(19) United States
(12) Patent Application Publication
(10) Pub. No.: US 2007/0042759 A1
(43) Pub. Date: Feb. 22, 2007

(54) System and method for providing mileage on wireless network

(76) Inventors: Woong Kim, Seoul (KR); Yong Joon Chung, Seoul (KR); Su Kil Bae, Gyeonggi-do (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/588,486

(22) Filed: Oct. 27, 2006

Related U.S. Application Data
(63) Continuation of application No. PCT/KR05/01185, filed on Apr. 25, 2005.

(30) Foreign Application Priority Data
Apr. 28, 2004 (KR) 10-2004-0029393

(51) Int. Cl. H04Q 7/38; H04Q 7/22

(52) U.S. Cl. 455/414.1

(57) ABSTRACT

Disclosed is a mileage providing system and method on a wireless network. When a user is connected through a wired network or a wireless network and requests transmission of predetermined contents, the system transmits the contents including a mileage module to a user terminal. After this, the mileage module is executed on the user terminal to which the contents are downloaded, a request of mileage provision is input through the mileage module, and the system provides mileages for contents downloading to the user. According to the present invention, management and provision of mileages for the contents downloading to the user terminal from a service provider through a wireless network is performed in real-time.

### CROSS-REFERENCE TO RELATED APPLICATIONS

This application is a continuation of PCT International Application Number PCT/KR2005/001185, filed on Apr. 25, 2005, designating the United States of America and published in the English language, which claims priority under 35 U.S.C. § 119 to Korean Application Number 10-2004-0029393 filed on Apr. 28, 2004. The disclosures of the above-referenced applications are hereby expressly incorporated by reference in their entireties.

### BACKGROUND OF THE INVENTION

1. Field of the Invention

The present invention relates to a mileage providing method on a wireless network and a system thereof. More specifically, the present invention relates to a system and method for providing a mileage according to contents provided through a wireless network and a system thereof.

2. Description of the Related Art

Since the Internet has become extremely popular, electronic commerce and information exchange for people around the world have been activated and are now readily accessible. In particular, the development of the Internet has allowed a plurality of users to receive various categories of information irrespective of their locations. Accordingly, portal sites for providing an information search service and a community service have been developed and are in use.

Users have been allowed to receive various kinds of information through the portal sites and to exchange information with other users through the community service, according to the development of the portal sites. Methods for as many users as possible to participate in their sites have been developed, since the portal sites receive increased advertisement and marketing incomes by application of user information when the portal sites obtain further allowable users and homepage counting hits by forming communities in cyberspace. Hence, marketing techniques for providing mileages when the user performs electronic transactions through a corresponding site, looks at specific advertisements, or uses contents have been executed in order to promote usage of sites.

Recently, the number of users who use an Internet service through WAP in addition to the WEB has increased so that the mileages are provided to the users when the users perform transactions or receive contents by accessing the WAP, which is a wireless network.

However, it is not easy to provide mileages to a user who has downloaded contents, such as programs, from among the users who use services through the conventional wireless network.

For example, a service provider transmits a program to a system of a mobile communication service provider (a mobile communication service system) and requests to transmit the program to the user's mobile terminal so as to provide the program thereto. The mobile communication service system transmits the program to the user's mobile terminal, and then notifies the service provider of a program transmission result.

However, since the mobile communication service system provides transmission results to the service provider for each established condition (e.g., a day), the service provider cannot provide mileages for the user's program download in real-time, even when the user has already used the provided contents.

Also, the service provider cannot manage users who have received the programs in real-time.

As to the conventional techniques for providing mileages to the service users through the wireless network, disclosed are Korean Published Application No. 2003-27290 entitled “System and method for depositing and settling cyber money in the game in a mobile terminal,” Korean Published Application No. 2003-1615 entitled “Marketing compensation method of software program distributed on communication network,” and Korean Published Application No. 2001-680 entitled “Integrated mileage management method using Explorer bar on Internet.”

In the Korean Published Application No. 2003-27290, a game program is downloaded to a user terminal, the user executes the game program, mileages are provided according to the game result, and hence, no mileages are provided until the game is over after the user executed the game program. Therefore, the mileages are not provided at each download and are not managed.

In the Korean Published Application No. 2003-1615, mileages are provided not to the user who has downloaded the game program to the user terminal but to another user who marketed the user to download the same program, and no mileages are substantially provided to the user having downloaded the program. Also, the prior art discloses no method for determining whether the program is downloaded to the user terminal, and hence, the mileages are not provided in real-time at each download.

In the Korean Published Application No. 2001-680, when the user having downloaded the program installs the program, an icon for controlling the program is generated on the web browser, and when the user clicks the icon, an Explorer bar is displayed and an access to the corresponding site is performed. After this, when the user is certified, the site provides a management tool for obtaining points to the user and provides links to other cooperated sites where the user can receive points by selecting the management tool to the user so that the user may receive points from the cooperated sites without any additional access process. However, the prior art only describes means for receiving points from a plurality of sites and discloses no means for the service provider to detect whether the user downloads the program.

### SUMMARY OF THE INVENTION

Technical Problem

It is an advantage of the present invention to provide mileages in real-time to a user when the user receives contents through a wireless network.

Technical Solution

In one aspect of the present invention, in a method for providing mileages to users in a system connected to a plurality of user terminals through a wired/wireless network, the method includes: a) allowing the system to transmit contents including a mileage module to the user terminal when the user, connected through a wired network or a wireless network, requests transmission of predetermined contents; b) allowing the system to authenticate the user when a mileage provision request is input through the mileage module after the mileage module is executed on the user terminal to which the contents are downloaded; c) determining whether mileage provision for the user's downloading of the contents has already been performed when the user is authenticated to be an allowable user; and d) providing mileages for the contents downloading to the user when no mileage provision is performed.

In another aspect of the present invention, in a method for providing mileages to users in a system connected to a plurality of user terminals through a wired/wireless network, the method includes: a) allowing the system to transmit contents including a mileage module to the user terminal when the user, connected through the wired network or the wireless network, requests transmission of predetermined contents; and b) allowing the system to provide mileages to the user according to the contents downloading when a mileage provision request is input through the mileage module after the mileage module is executed on the user terminal to which the contents are downloaded.

In still another aspect of the present invention, in a system connected to a plurality of user terminals through a wired/wireless network and providing mileages to users, the system includes: a contents providing server for providing corresponding contents to the user terminal according to a request of the user who is connected through the wired network or the wireless network, wherein a mileage module is inserted into the contents; and a processing sever for providing mileages to the user when the mileage module is executed on the user terminal to which the contents are downloaded and the user terminal is connected.

In still yet another aspect of the present invention, in a method for providing mileages to users in a system connected to a plurality of user terminals through a wired/wireless network, the method includes: a) allowing the system to transmit contents including a mileage module to the user terminal when the user, connected through the wired network or the wireless network, requests transmission of predetermined contents; b) displaying a mileage receiving menu corresponding to the mileage module when the mileage module is executed on the user terminal to which the contents are downloaded; c) allowing the user terminal to be connected to the system when the user selects the mileage receiving menu; d) authenticating whether the connected user is an allowable user; e) determining whether mileage provision for the user's contents downloading is performed when the connected user is found to be an allowable user; and f) providing mileages for the contents downloading to the user when no mileage provision is performed.

### BRIEF DESCRIPTION OF THE DRAWINGS

FIG. 1 shows a network connection diagram for a mileage providing system through a wireless network according to an exemplary embodiment of the present invention.

FIG. 2 shows the contents providing server shown in FIG. 1.

FIG. 3 shows the processing server and authentication server shown in FIG. 1.

FIG. 4 shows a flowchart of a method for providing mileages through a wireless network according to an exemplary embodiment of the present invention.

FIG. 5 and FIG. 6 show a detailed flowchart of a method for providing mileages through a wireless network according to an exemplary embodiment of the present invention.

FIG. 7 shows an exemplified screen displayed on the user terminal according to an exemplary embodiment of the present invention.

FIG. 8 and FIG. 9 show a detailed flowchart of a method for providing mileages through a wireless network according to a second exemplary embodiment of the present invention.

FIG. 10 shows an exemplified screen displayed on the user terminal according to the second exemplary embodiment of the present invention.

### DETAILED DESCRIPTION OF THE PREFERRED EMBODIMENT

In the following detailed description, only the preferred embodiments of the invention have been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which similar descriptions are provided have the same reference numerals.

In an exemplary embodiment of the present invention, the contents are provided when mileage receiving means are inserted into the contents so that the service provider may detect download-finished states of contents provided to a user through a mobile communication service system when the service provider does not receive transmission results from the mobile communication service system. Therefore, when the user, having received the contents, accesses the service provider's system by executing the means, the user receives the mileages. In this instance, the term of “mileages” includes all kinds of compensation means (e.g., cyber money and points) given according to acts performed on the network. Further, the contents include things that can be provided to the user through the wireless network, for example, text, moving pictures, images, and programs.

A configuration of the mileage providing system will now be described.

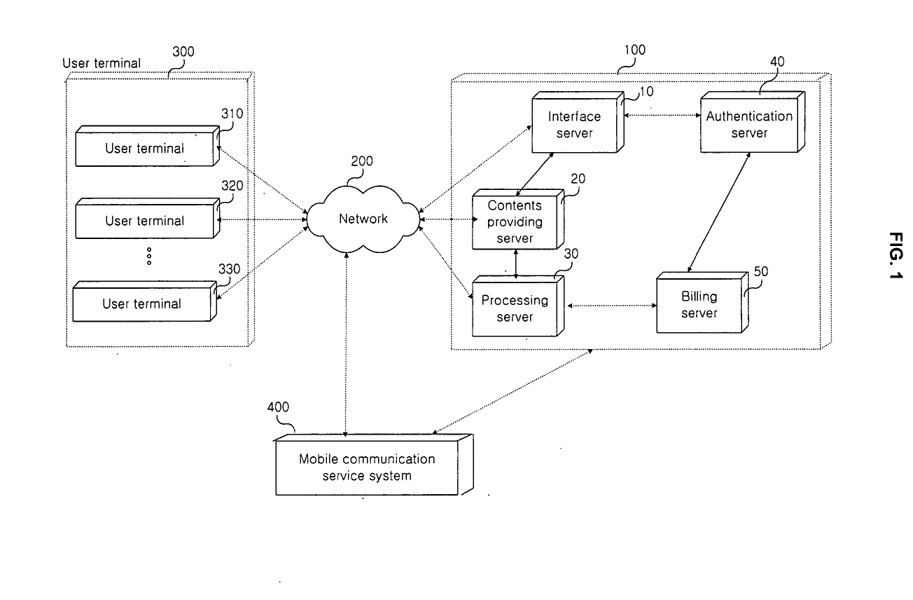

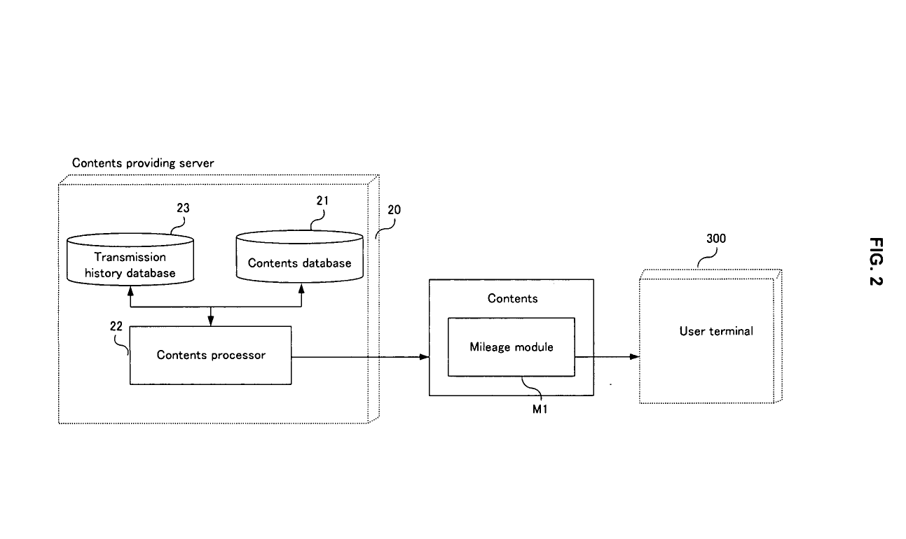

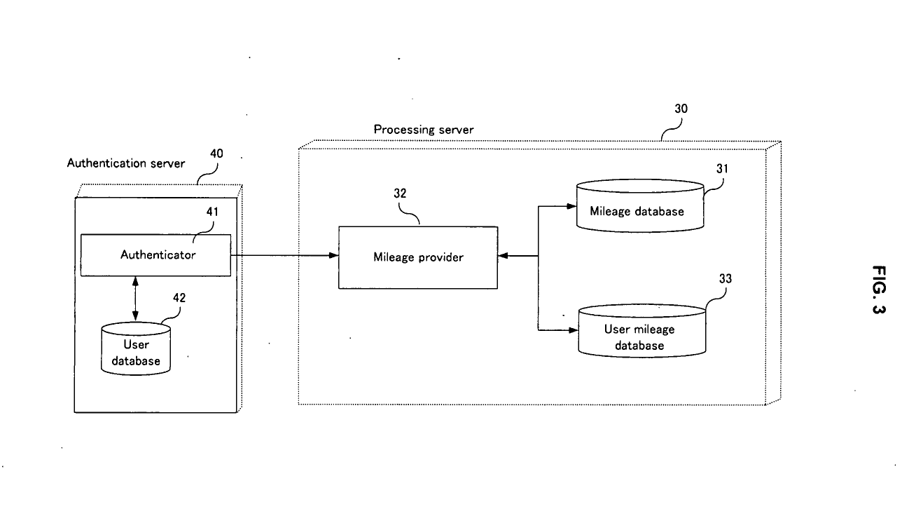

FIG. 1 shows a network connection diagram for a mileage providing system through a wireless network according to an exemplary embodiment of the present invention, and FIG. 2 and FIG. 3 show detailed schematic diagrams for respective servers shown in FIG. 1.

As shown in FIG. 1, the mileage providing system 100 is connected to a plurality of user terminals 310, 320, 330, . . . (which will be jointly denoted as 300 for ease of description) through a network 200 (including a wired network and a wireless network), and provides contents to the user terminal 300 through the network 200. In particular, the mileage providing system 100 is connected to a mobile communication service system 400 and provides the contents through the network 200.

The user terminal 300 represents a communication device for accessing the mileage providing system 100 through the network 200, and various communication devices including a mobile terminal, a computer, and an Internet TV can be used as the user terminal 300.

The mileage providing system 100 for providing contents to the user terminal 300 and mileages according to the user's usage of the contents includes an interface server 10, a contents providing server 20, a processing server 30, and an authentication server 40, and may further optionally include a billing server 50.

The interface server 10 processes the accesses by the users who access through the network, and may include a WAP server for processing accesses by the users who access through the wireless Internet and a WEB server for processing accesses by the users who access through the wired Internet.

As shown in FIG. 2, the contents providing server 20 stores a plurality of contents provided by the mileage providing system 100, and transmits predetermined contents selected by the user to the user terminal 300. In detail, the contents providing server 20 includes a contents database 21 for storing a plurality of contents, a contents processor 22 for transmitting contents stored in the contents database 21 to the user terminal 300, and a transmission history database 23 for storing contents transmission history. The contents processor 22 may insert mileage providing means into the contents and transmit them to the user terminal 300 through the network 200. For ease of description, the means will be referred to as a “mileage module” that can be a virtual machine (VR). The contents processor 22 may insert the mileage module M1 into the contents and then transmit them, and may also generate the contents transmitted through the network to be contents to which the mileage module M1 is inserted in the earlier stage. The mileage module M1 may include link information for an access to the mileage providing system 100.

The contents provided by the contents providing server 20 are transmitted to the mobile communication service system 400 through the interface server 10, and are finally transmitted to the user terminal 300 through the mobile communication service system 400. The technique for transmitting the contents to the user terminal 300 through the mobile communication service system 400 on the network is obvious to a person skilled in the art and will not be described herein.

The processing server 30 provides mileages to the users who have received the contents through the network. As shown in FIG. 3, the processing server 30 includes a mileage database 31 for establishing mileages for the respective contents, a mileage provider 32 for providing mileages to the user according to information stored in the mileage database 31, and a user mileage database 33 for storing information on the mileages given to the respective users.

The mileage database 31 stores mileages to be provided when the contents are downloaded corresponding to identification information given to respective contents.

The user mileage database 33 stores information on the mileages given for the respective users, and further, may store information on the reference by which the mileages are provided. For example, the user mileage database 33 may store a mileage providing day, provided mileages, a total of mileages, information on the contents for the provided mileages, and a time when the contents are downloaded for each user ID.

The authentication server 40 manages and performs the user's registration to the mileage providing system 100 and log-in to the same. The authentication server 40 includes an authenticator 41 for performing member registration and log-in, and a user database 42 for storing information on users who are allowable as members in the mileage providing system 100. The user database 42 may store personal information including a password, a name, a residence number, a sex, an age, and a telephone number for each user ID.

The billing server 50 is optional, and bills the user's contents download.

In the mileage providing system according to the exemplary embodiment of the present invention, the respective servers 10 to 50 are classified according to their functions, are not restricted to the above-described classification, and are variable in many respects. For example, the respective servers 10 to 50 realized to include the respective databases 21, 23, 1, 33, and 42 may be realized to be separate from the corresponding databases, and may also be integrated into a single database server.

Further, components of the servers are optional and may be realized to be respective servers and process corresponding functions. In addition, classification of the databases is not restricted to the above-noted classification.

An operation of the mileage providing system according to the embodiment of the present invention will now be described with reference to the above-described configuration.

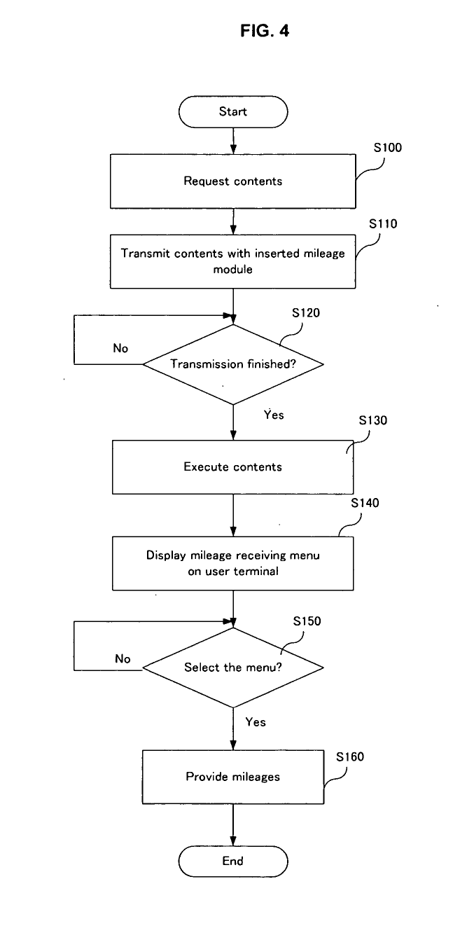

FIG. 4 shows a mileage providing method according to an exemplary embodiment of the present invention.

As shown in FIG. 4, the user accesses the mileage providing system 100 through the network 200 and requests transmission of contents in step S100. In this instance, the user may request transmission of contents by accessing the mileage providing system 100 through a wireless network or a wired network.

The contents providing server 20 transmits the contents requested by the user to the user terminal 300 through the mobile communication service system 400 in step S110, and in particular, the mileage module M1 is inserted into the provided contents.

Corresponding contents are performed in steps S120 and S130 when downloading of the contents to the user terminal 300 is finished. In this instance, the user may directly perform the downloaded contents, or the downloaded contents may be automatically performed. When the contents are performed, the mileage module M1 inserted into the contents is performed, and the “Mileage receiving menu” corresponding to the mileage module M1 is displayed on the screen of the user terminal 300, in step S140.

When the user selects the “Mileage receiving menu,” the user terminal 300 is connected to the processing server 30 of the mileage providing system 100, and the processing server 30 provides predetermined mileages to the user who is connected through the “Mileage receiving menu” in steps S150 and S160.

The mileage providing method with reference to components of the system will now be described in further detail.

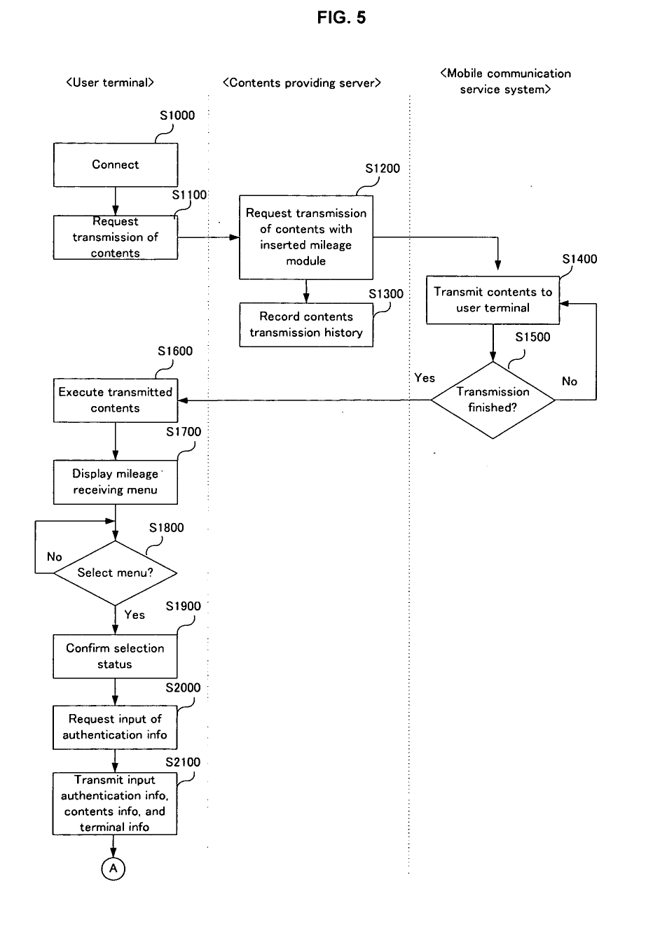

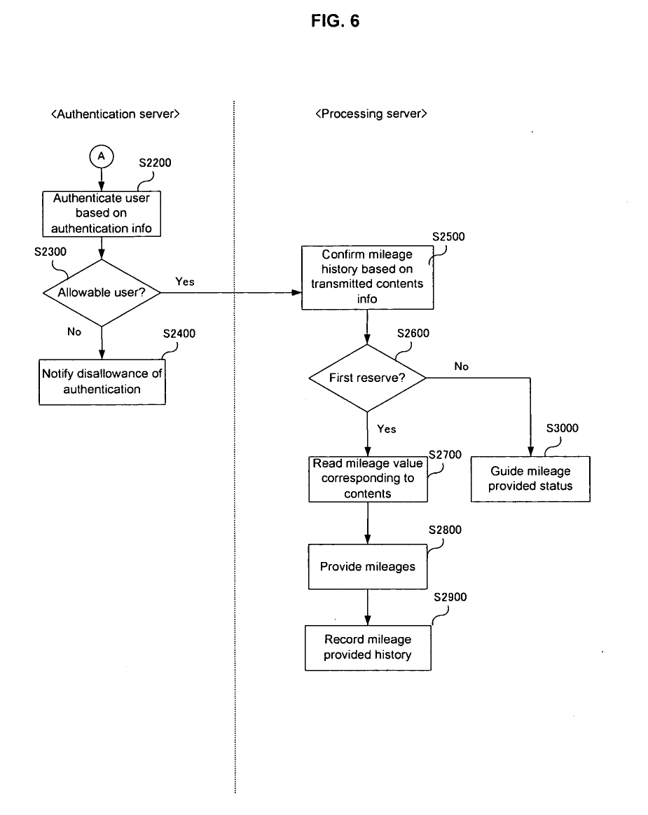

FIGS. 5 and 6 show a detailed flowchart for the mileage providing method according to the exemplary embodiment of the present invention.

As shown in FIG. 5, the user accesses the mileage providing system 100 through the network 200 and requests transmission of contents in steps S1000 and S1100. In this instance, the user may request transmission of contents by accessing the mileage providing system 100 through a wireless network or a wired network.

The contents processor 22 of the contents providing server 20 extracts the contents requested by the user from the contents database 21 and transmits the contents to the mobile communication service system 400 so as to transmit the contents to the user terminal 300 in step S1200. In this instance, the contents processor 22 inserts the mileage module M1 into the contents and transmits them, or transmits the contents without an additional process when the mileage module M1 is inserted into the contents.

The contents processor 22 records information on the contents provided to the user in the transmission history database 23 in step S1300. That is, the contents processor 22 records ID information on the contents provided in correspondence to the user ID and information on the providing time.

The mobile communication service system 400 transmits the contents transmitted by the contents providing server 20 to the user terminal 300 in steps S1400 and S1500, and the contents are performed in step S1600 when the transmission of contents to the user terminal 300, that is, a download, is finished. For example, assuming that the contents downloaded by the user are a game program, when the program downloading is finished, the user performs the downloaded game program, and menus for performance of the game and the “Mileage receiving menu” caused by performance of the mileage module M1 are displayed on the screen of the user terminal 300 in step S1700.

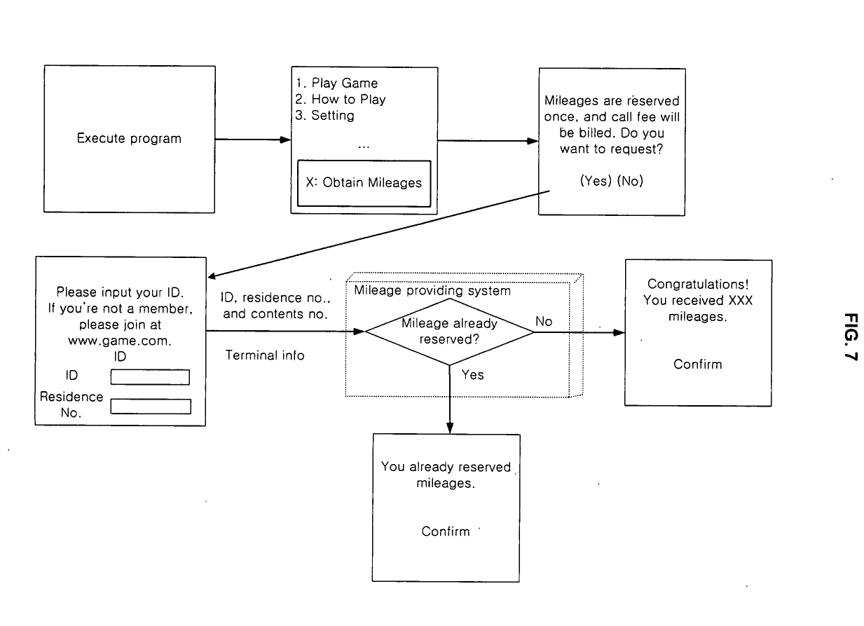

FIG. 7 shows an exemplified screen displayed on the user terminal when the downloaded contents are performed. As shown in FIG. 7, when the user plays the game program, menus including game-related menus of 1) Play Game, 2) How to Play the Game, and 3) Settings and a menu of X) Receive Mileages are displayed.

When the downloaded contents are performed, the Receive Mileages menu is displayed, and the user selects it in step S1800, the user terminal 300 is connected to the mileage providing system 100, and the mileage providing system 100 provides mileages to the user.

In detail, when the Receive Mileages menu is selected as exemplified in FIG. 5, a screen for inquiring whether to request mileages together with a brief explanation on mileage provision is displayed on the user terminal 300 by the mileage module M1 in step S1900, and when the user requests to receive the mileages, a process for inputting information on an ID and a residence number for user authentication is requested in step S2000. Here, the ID and residence number are used for user authentication, although the embodiment is not restricted to them. When the user inputs the ID and residence number, the mileage module M1 transmits ID formation of the contents and a radio number of the terminal, together with the ID and residence number input by the user, to the mileage providing system 100 in step S2100.

As shown in FIG. 6, the authentication server 40 of the mileage providing system 100 determines the user to be an allowable user in step S2200 and S2300 when the ID and the residence number transmitted by the user terminal 300 correspond to the residence number of the user database 42 corresponding to the ID. In this instance, the user may additionally provide the terminal's radio number and residence number to the mobile communication service system 400, and may authenticate whether the user is the terminal's actual user in order to confirm whether the user is the actual terminal user who is registered to the mobile communication service system 400. When authentication information does not correspond to the information stored in the user database 42, the authentication server 40 notifies disallowance of authentication of the terminal 300 and thus performs again a process of inputting authentication information.

When the user is determined to be an allowable user according to the authentication process by the authentication server 40, the mileage provider 32 of the processing server 30 searches the user mileage database 33 based on the contents identification information and the user ID provided by the terminal 300 to determine whether the user has received mileages based on the contents in step S2500.

When the user has never received mileages according to the contents, the mileage provider 32 provides mileages to the user based on the mileage value that corresponds to the corresponding contents identification information of the mileage database 31 in steps S2600 to S2800, and a mileage provided status is displayed on the screen of the user terminal 300 as illustrated in FIG. 7. Next, the mileage provider 32 records a mileage provision history in the user mileage database 33 in step S2900, thereby recording the mileage provided corresponding to the user ID of the user mileage database 33, the total mileages, and the contents identification information that is a reference to the mileage provision.

When the user has already received mileages in respect to the contents, the mileage provider 32 notifies the user terminal 300 of a mileage provided status in step S3000, and a message for displaying that the mileages are already provided is displayed as shown in FIG. 6.

As described, a mileage request module is inserted into the contents provided to the user terminal and they are transmitted to the user terminal, and hence, when the contents downloading is finished, the user may easily receive mileages from the mileage providing system 100 by using the module. Hence, the mileage providing system 100 can easily check the contents downloaded status to the user terminal 300 without receiving a notice of transmission result from the mobile communication service system 400. As a result, management and provision for contents downloading is performed in real-time.

In the described embodiment, an additional identification flag may be included in the mileage module inserted into the contents and then may be transmitted in order to prevent the case in which the user repeatedly downloads the same contents and reserves mileages.

A method for providing mileages by using an identification flag will now be described.

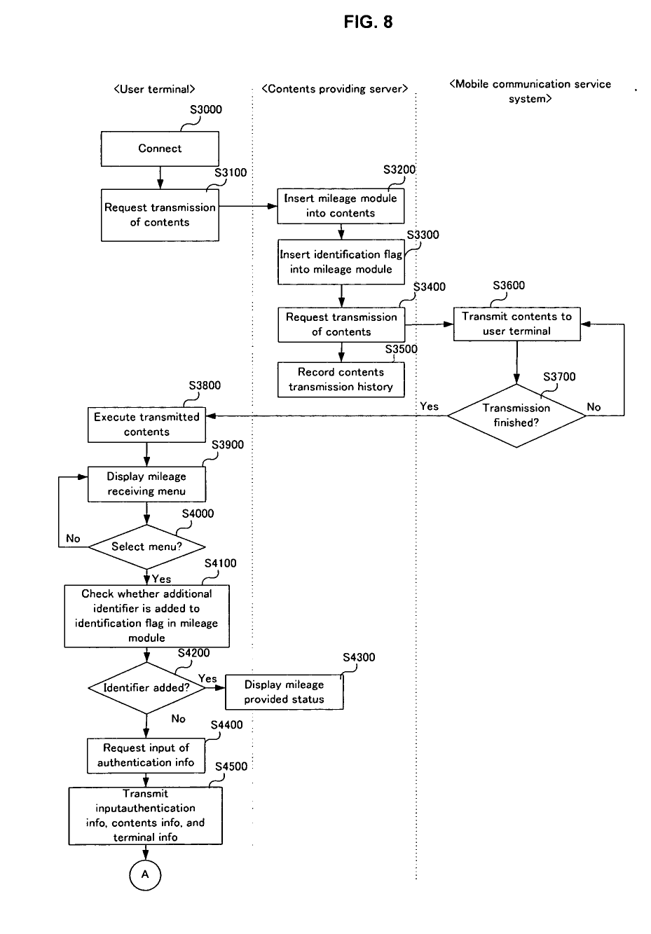

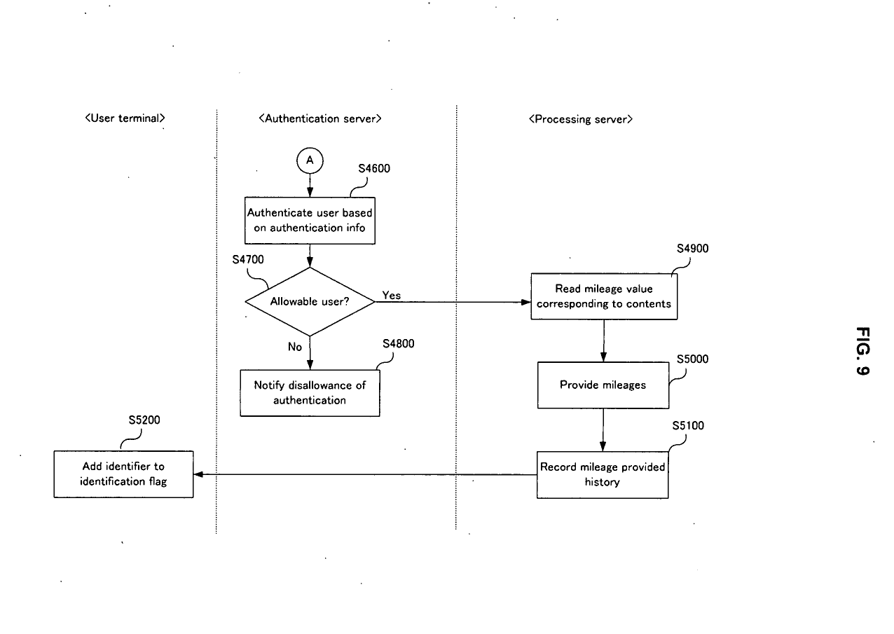

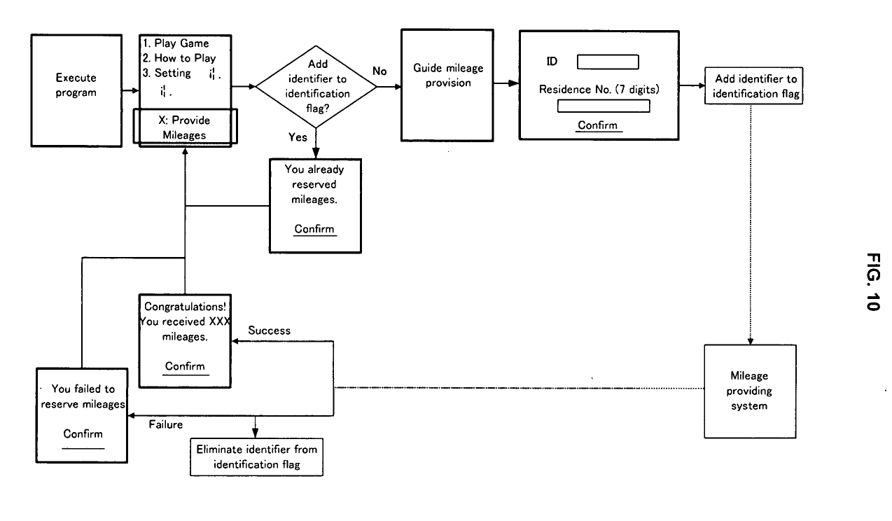

FIG. 8 and FIG. 9 show a detailed flowchart of a method for providing mileages through a wireless network according to a second exemplary embodiment of the present invention.

As shown in FIG. 8, when the user requests transmission of contents, the contents providing server 20 inserts a mileage module M1 into corresponding contents and transmits them in steps S3000 to S3200, in this instance, an identification flag (or an identification file) for an iterative reserve of mileages is added to the mileage module M1, and the contents providing server 20 transmits the contents to the mobile communication service system 400 and requests transmission in steps S3300 to S3500.

When the contents are downloaded to the user terminal 300 and are executed and the user then selects the “Mileage receiving menu” in steps S3600 to S4000, the mileage module M1 identifies the identification flag to determine whether an identifier for displaying a mileage reserved status is added to the identification flag in step S4100. In this instance, the mileage module M1 may determine an identifier added status to the identification flag, and the mileage provider 32 of the mileage providing system 100 may determine the same in cooperation with the mileage module M1.

When the identifier for displaying a mileage reserved status is added to the identification flag, the user is determined to have received the mileages for downloading of the contents, and a mileage provided status is displayed on the user terminal 300 in steps S4200 and S4300. In this instance, the mileage module M1 performs no operation for receiving mileages.

When the identifier is not added to the identification flag in step S4200, the user is determined to have not received the mileages for downloading of the contents, the mileage module M1 provides authentication information for the user to the mileage providing system 100, and the mileage providing system 100 provides mileages to the user in steps S4400 to S5100 as shown in FIG. 7B. The mileage module M1 of the user terminal 300 adds an identifier for showing a mileage reserve to the identification flag and records that the user has received mileages by using the contents in step S5200. Therefore, no operation for receiving mileages is performed because of the identifier when the user requests mileages for the contents.

The above exemplary embodiment has been described such that the mileage module M1 adds an identifier to the identification flag after the mileages for the contents are provided, and differing from this, it is also possible to perform the process for the mileage module to add an identifier to the identification flag when no identifier is added to the identification flag in step S4200, and to eliminate the identifier added to the identification flag when the mileage reserve is notified to be failed (e.g., a case in which user authentication is not performed) by the mileage providing system 100. However, the identifier is maintained to be added to the identification flag when the mileage reserve is successfully performed.

FIG. 9 shows an exemplified screen displayed on the user terminal according to a second exemplary embodiment of the present invention when the mileage module adds an identifier to an identification flag before the mileage providing system 100 performs a mileage reserve process while preventing double reserve of mileages by using the identification flag.

The mileage received status is displayed by adding an additional identifier to an identification flag in the above-described embodiment, and differing from this, it is also possible to display the mileage received status by varying the value of the identification flag. Therefore, the variation of the identification flag includes the case in which the value of the identification flag is varied as well as the case in which an additional identifier is added to the identification flag. Further, the identification flag is a term given for ease of description, and has a file format in addition to the general flag format.

Thus, according to the second embodiment, the user is prevented from repeatedly reserving the mileages by using the same contents.

In addition, it is possible to use the time at which the contents are downloaded and are initially driven in order to prevent the case in which the user repeatedly downloads the same contents and reserves mileages. In this instance, when the initial driving time of the contents is provided from the user terminal and is stored, and mileage provision for the same contents is requested from a subsequent accessing terminal, the driving time for the contents is compared to the initial driving time to determine whether the mileages have been provided, and the mileages are provided according to the determination results.

Also, when the mileage provisions for the same contents are requested, the mileages may be provided respectively when settlements are performed for the respective contents downloading cases.

The above-described game method may be realized in a program format stored in a computer-readable recording medium that includes recording devices for computer-readable data, for example, a CD-ROM, a magnetic tape, a floppy disk, and a carrier wave format (e.g., for Internet transmission).

While this invention has been described in connection with what is presently considered to be the most practical and preferred embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

According to the present invention, the user can easily receive mileages from the provider by using the module included in the contents when the contents downloading to the user terminal from the service provider through the wireless network is finished.

Also, the service provider may easily check the contents downloaded status to the user terminal according to the access through the module by the user who has downloaded the contents without additional transmission results, thereby managing and providing the mileages for the contents downloading in real-time.

What is claimed:

1. A system configured to communicate with at least one user terminal through a communications network and for providing mileage to users, the system comprising:
a content providing server configured to provide content according to a request by a user terminal, the user terminal being in communication with the communications network, wherein the content comprises a mileage module; and
a processing server configured to provide mileage to the user in response to the execution of the mileage module in the user terminal that has requested the contents.

2. The system of claim 1, wherein the user terminal that has requested the contents has the contents downloaded to it.

3. The system of claim 1, wherein the mileage module is executed when the contents are performed.

4. The system of claim 1, wherein the communication network comprises at least one of a wired and wireless subnetwork.

5. The system of claim 1, wherein the content providing server comprises:
a contents database configured to store a plurality of contents; and
a contents processor configured to transmit the contents stored in the contents database to the user terminal, and to insert a mileage module into the contents and to transmit the contents and the mileage module when the insertion operation is completed.

6. The system of claim 1, wherein the processing server comprises:
a mileage database configured to establish mileages provided for respective contents;
a user mileage database configured to store information about the mileages provided to the users; and
a mileage provider configured to search the user mileage database to determine whether the mileage has been provided based on content identification information provided by the user terminal.

7. The system of claim 1, wherein when the downloading of contents to the user terminal is finished, the mileage module is executed to display a mileage receiving menu, and the user terminal communicates with the mileage providing system in correspondence with the user's selecting the menu.

8. The system of claim 1, further comprising an authentication server configured to authenticate the user connected through the network.

9. A method for providing mileage to a user of a terminal configured to communicate through a communication network, the method comprising:
allowing the network to transmit contents including a mileage module to the user terminal when the user, communicating via the communication network, requests transmission of predetermined contents; and
allowing the network to support the provision of mileage to the user according to the contents downloading when a mileage provision request is initiated by the mileage module after the mileage module is executed in the user terminal that has requested the contents.

10. The method of claim 9, wherein the user terminal that has requested the contents has the contents downloaded to it.

11. The method of claim 9, wherein the mileage module is executed when the contents are performed.

12. The method of claim 9, wherein the communication network comprises at least one of a wired or wireless subnetwork.

13. The method of claim 9, wherein allowing the network to support the provision of mileage further comprises:
performing the contents in the user terminal when downloading of contents has finished;
executing the mileage module and displaying a mileage receiving menu on the user terminal when the contents are executed; and
allowing the mileage module to transmit identification information on the contents to the system and to request mileage provision when the user's mileage receiving menu is selected.

14. A method of providing mileage to users of a mileage providing system configured to communicate with a plurality of user terminals through a communication network, the method comprising:
allowing the system to transmit contents including a mileage module to the user terminal in response to the user terminal requesting transmission of predetermined contents, wherein an identification flag for preventing a doubled mileage reserve is added to the mileage module;
determining whether the identification flag added to the mileage module has been modified to signify that the said mileage has already been provided when a mileage provision request is input via the terminal through the mileage module after the mileage module is executed on the user terminal that has requested the contents;
determining that the mileages for the contents have already been provided and terminating the operation for receiving the mileages when identification flag added to the mileage module is modified;
allowing the system to authenticate the user when the identification flag added to the mileage module is not modified; and
providing mileages to the user according to the contents downloading when the user is authenticated to be an allowable user.

15. The method of claim 14, wherein the mileage module is executed when the contents are performed.

16. The method of claim 14, wherein the communication network comprises at least one of a wired or wireless subnetwork.

17. The method of claim 14, wherein providing mileages to the user comprises modifying the identification flag added to the mileage module when the mileage provision is finished.

18. The method of claim 14, wherein allowing the system to authenticate the user comprises displaying that mileages for the contents have been provided by modifying the identification flag when the identification flag added to the mileage module is not modified, and providing mileages to the user comprises maintaining the modification of the identification flag added to the mileage module when the provision of mileages is finished and initializing the modification of the identification flag added to the mileage module when the provision of mileages has failed.

19. A method of providing mileage to users in a mileage providing system configured to communicate with a plurality of user terminals through a communication network, the method comprising:
allowing the system to transmit contents including a mileage module to the user terminal when the user terminal, connected via a wired network or a wireless network, requests transmission of predetermined contents;
allowing the system to authenticate the user when a mileage provision request is input through the mileage module after the mileage module is executed on the user terminal to which the contents are downloaded;
determining whether mileage provision for the user's downloading of the contents has already been performed when the user is authenticated to be an allowable user; and
providing mileages for the contents downloaded to the user when no mileage provision has been performed.

20. The method of claim 19, wherein the mileage module is executed when the contents are performed.

21. The method of claim 19, wherein the communication network comprises at least one of a wired or wireless subnetwork.

22. The method of claim 19, wherein allowing the system to authenticate the user further comprises:
executing the contents on the user terminal when downloading of the contents is finished;
further executing the mileage module and displaying a mileage receiving menu on the user terminal when the contents are executed; and
allowing the mileage module to transmit identification information on the contents to the mileage providing system and to request mileage provision when the user's mileage receiving menu is selected.

23. The method of claim 22, wherein allowing the mileage module to transmit identification information comprises:
requesting the user to input authentication information; and
transmitting identification information on the downloaded contents together with the input authentication information to the mileage providing system when the user inputs the authentication information.

24. The method of claim 19, wherein providing mileages for the contents downloaded to the user comprises:
determining whether mileages for the contents have already been provided by referring to a database for storing a mileage provided history based on contents identification information transmitted through the mileage module installed on the user terminal.

25. A method for providing mileage to users of a mileage providing system configured to communicate with a plurality of user terminals through a wired/wireless network, the method comprising
allowing the system to transmit contents including a mileage module to the user terminal when the user terminal, communicating via the wired network or the wireless network, requests transmission of predetermined contents;
displaying a mileage receiving menu corresponding to the mileage module when the mileage module is executed on the user terminal to which the contents are downloaded;
allowing the user terminal to communicate with the system when the user selects the mileage receiving menu;
authenticating whether the connected user is an allowable user;
determining whether the award of mileage for the user terminal's downloading of content has been performed when the communicating user terminal is found to be an allowable user; and
providing mileages for the contents downloaded to the user when no award of mileage has been performed.

26. The method of claim 25, wherein the mileage module is executed when the contents are performed.
